(19) United States
(12) Patent Application Publication
(10) Pub. No.: US 2023/0273927 A1
(43) Pub. Date: Aug. 31, 2023

(54) SYSTEMS AND METHODS FOR AGGREGATING CLIENT DATA

(71) Applicant: BOSS INSIGHTS INC., Toronto (CA)

(72) Inventors: Luke Moynihan, Toronto (CA); Keren Moynihan, Toronto (CA)

(21) Appl. No.: 17/640,685

(22) PCT Filed: Sep. 4, 2020
(86) PCT No.: PCT/IB2020/058264

§ 371 Date: Feb. 2, 2023

Related U.S. Application Data
(60) Provisional application No. 62/895,680, filed on Sep. 4, 2019.

(51) Int. Cl. G06F 16/2455; G06F 16/28; G06F 21/62

(52) U.S. Cl. CPC G06F 16/24556; G06F 16/288; G06F 21/6218

(57) ABSTRACT

An example method includes: storing, at a server, associations between a plurality of data owner accounts and a data collecting entity account; for each data owner account: obtaining, from a respective third-party platform, raw client data associated with the data owner account; mapping the raw client data according to a common data model to generate structured client data; and storing the structured client data at a structured data repository; and in response to a summary request for the data collecting entity account, aggregating the structured client data for the data owner accounts associated with the data collecting entity account and outputting the aggregated structured client data.

### FIELD

The specification relates generally to data acquisition systems, and more particularly to systems and methods for aggregating client data for a plurality of data owning entities from respective third-party platforms.

### BACKGROUND

Businesses, individuals and other entities may own data, used, for example to manage daily operations, track assets and the like. Often, data owners may utilize third-party platforms to manage their data and support certain operations and capabilities within a certain functional basis (e.g., functional bases may include accounting, sales/customer relationship management, and similar). Data owners may additionally have agreements with data collecting entities to allow the data collecting entities access to their data. For example, the data collecting entity may access the data owner's data to provide an analysis or other service. For example, an accounting firm providing tax filing services or risk management services may require access to accounting and/or financial data. In another example, a bank considering and/or managing a loan may require access to financial and internal management data. As each data owner may store the desired data at a third-party platform, and the data collecting entity may require data from multiple data owners, present systems and methods of acquiring the data for the data owner from the third-party platforms may be time-consuming, error prone, and expensive due to the need to repeat the data acquisition process for each data owner at each third-party platform.

### SUMMARY

According to an aspect of the present specification, a method of aggregating client data is provided. The method includes: storing, at a server, associations between a plurality of data owner accounts and a data collecting entity account; for each data owner account: obtaining, from a respective third-party platform, raw client data associated with the data owner account; mapping the raw client data according to a common data model to generate structured client data; and storing the structured client data at a structured data repository; and in response to a summary request for the data collecting entity account, aggregating the structured client data for the data owner accounts associated with the data collecting entity account and outputting the aggregated structured client data.

According to another aspect of the present specification, a server for aggregating client data is provided. The server includes: a memory configured to store associations between a plurality of data owner accounts and a data collecting entity account; a processor interconnected with the memory, the processor configured to: for each data owner account: obtain, from a respective third-party platform, raw client data associated with the data owner account; map the raw client data according to a common data model to generate structured client data; and store the structured client data at a structured data repository; and in response to a summary request for the data collecting entity account, aggregate the structured client data for the data owner accounts associated with the data collecting entity account and outputting the aggregated structured client data.

### BRIEF DESCRIPTION OF DRAWINGS

Implementations are described with reference to the following figures, in which:

FIG. 1 depicts a block diagram of an example system for aggregating client data;

FIG. 2 depicts a block diagram of certain internal components of a server in the system of FIG. 1;

FIG. 3 depicts a flowchart of a method of aggregating client data in the system of FIG. 1;

FIG. 4 depicts a flowchart of a method of requesting client data at block 310 of the method of FIG. 3;

FIG. 5 depicts a flowchart of a method of outputting aggregated structured client data at block 340 of the method of FIG. 3; and

FIG. 6 depicts a flowchart of a method of synchronizing client data in the system of FIG. 1.

### DETAILED DESCRIPTION

Presently, data collecting entities may utilize software development tools to acquire data from third-party platform sources, however present systems do not provide semantic data mapping, transforming and redistribution and are blind to the semantic meaning of the data being mapped. Additionally, present systems typically focus on a single functional basis (e.g., integration and mapping of banking information). Further, present systems which allow the integration and mapping from multiple third-party platform sources are provided to the data owner (i.e., to present the data owner with their own data stored at different third-party platforms), and do not provide integration and mapping of data from multiple data owners to a data collecting entity which has access to the data owners' data.

The present disclosure is directed to a system and method for aggregating client data. In particular, a server may connect to different third-party platforms acting as data sources to retrieve the client data and map the client data to a common data model. The structured client data is then stored at the server for querying, analysis or re-distribution. The common data model reduces the difficulty in analyzing information in a consistent manner and enables comparing data between data owners, or from different third-party platforms. Additionally, the server may manage both data owner accounts and data collecting entity accounts to allow the transfer or access of data owner client data by the data collecting entity accounts based on permission data and associations between the data owner accounts and the data collecting entity accounts.

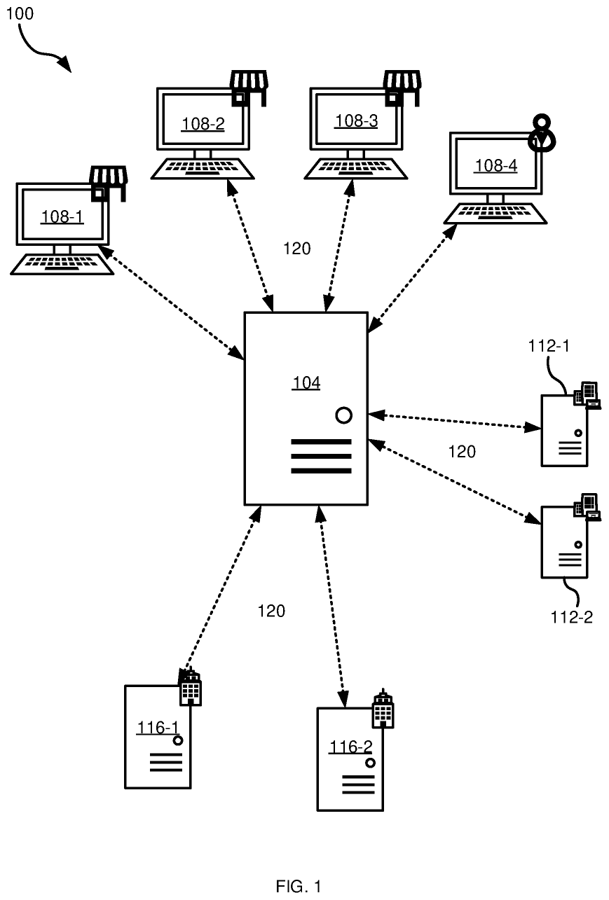

FIG. 1 depicts an example system 100 in accordance with the teachings of the present disclosure. The system 100 includes a server 104 configured to aggregate the client data for a plurality of data owners operating respective data owner computing devices, of which four example data owner computing 108-1, 108-2, 108-3, 108-4 (referred to generically as a data owner computing devices 108 and collectively as the data owner computing devices 108; this nomenclature is used elsewhere herein) are depicted. The system 100 also includes a plurality of third-party services operating respective third-party platforms, of which two example third-party platforms 112-1, 112-2 are depicted. The aggregated client data may be provided to one or more data collecting entities operating data collecting computing devices, of which data collecting computing devices 116-1, 116-2 are depicted.

The server 104 is generally configured to obtain client data from the third-party platforms 112 for the data owners, map the client data according to a common data model to generate structured client data, and store the structured client data at a structured data repository. The server 104 is therefore able to aggregate disparate client data from multiple third-party platforms to a structured format and provide the aggregated structured client data to data collecting entities upon request. In particular, the aggregate structured client data provided to a given data collecting entity may be limited to the client data for data owners associated with the data collecting entity, and further limited by a data identifier type of the client data for the data owners. The internal components and functionality of the server 104 will be described in further detail below. As will be appreciated, in some examples, the functionality of the server 104 may be implemented on any suitable server environment, including a plurality of cooperating servers, a cloud-based server environment, and the like.

The data owners may be business or corporate entities, individuals, or other entities, such as academic or governmental organizations, or the like. The data owners own data pertaining to their respective entities, including, but not limited to financial and/or accounting data, customer relationship management data, internal data (e.g., related to personnel, corporate structure, or the like) and similar. Such data is referred to herein as client data. The data owners may operate the data owner computing devices 108 (also referred to herein as simply the computing devices 108). The computing devices 108 may be, for example, servers, personal computers, laptops, tablets, mobile devices, or the like. The computing devices 108 may be configured to run applications to allow the input and management of the client data, as well as communicate with the third-party platforms 112 and the server 104 to manage the client data.

In particular, the data owners may store their client data at the third-party platforms 112 after inputting the client data at the computing devices 108. The third-party platforms 112 may be servers, cloud-based systems, or the like, supporting the functionality provided by the third-party services. Generally, the third-party platforms 112 manage the client data, and in particular, client data having a specific functional basis. In particular, the data owners may use different third-party platforms 112 based on the functional requirements and basis of the client data. For example, the data owners may employ different third-party services to manage their finances, accounting, and customer relations, and hence the financial data, accounting data, and customer relationship management data may be stored at different third-party platforms 112. Additionally, multiple third-party services may offer similar functional services (e.g., QuickBooks, FreshBooks, NetSuite, and others offer accounting services), and hence different data owners may store client data having the same functional basis at different third-party platforms 112. In some examples, a given owner may also store client data having the same or similar functional basis at different third-party platforms 112 (e.g., to manage different aspects of finances, such as invoicing and payroll, which may be supported by a single third-party service, but which the data owner may choose to manage separately based on the ease of use of the third-party service). As will be appreciated, the system 100 may include more than two third-party platforms 112 based on the third-party services employed by the data owners.

The data owners may also have agreements with the data collecting entities to share their client data with the data collecting entities. For example, the data collecting entity may be an accounting firm managing a data owner's tax accounts, or a bank loaning the data owner money. The data collecting entities may similarly operate the data collecting computing devices 116 (also referred to herein as simply the computing devices 116). The computing devices 116 may be servers, personal computers, laptops, tablets, mobile devices, or the like. As will be appreciated, the system 100 may include more than two data collecting entities operating corresponding data collecting computing devices 116.

The computing devices 108, the third-party platforms 112, and the computing devices 116 are in communication with the server 104 via communications links 120. The communication links 120 may be wired or wireless or a combination of wired and wireless communication links. For example, the communication links may be provided by a wireless local area network (WLAN) deployed by one or more access points (not shown). In other examples, the communication links 120 may include one or more wide-area networks such as the Internet, mobile networks, and the like. The computing devices 108, the third-party platforms 112 and the computing devices 116 may also, in some examples, be in direct communication with one another (not shown).

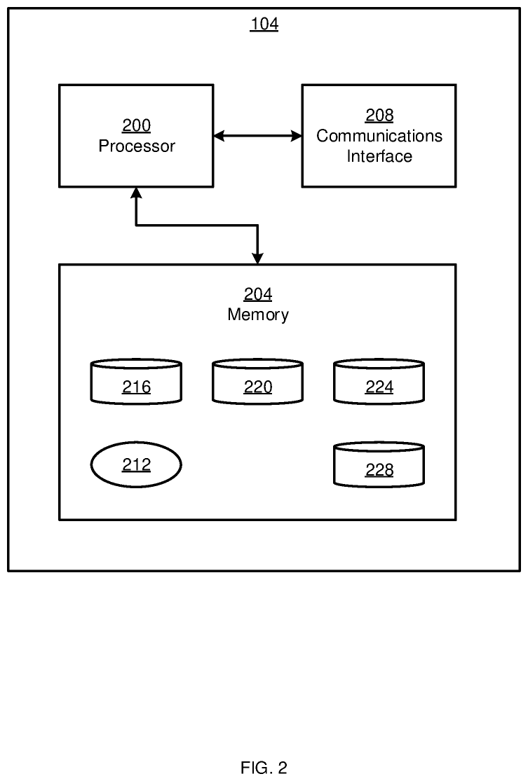

Referring now to FIG. 2, a block diagram of certain internal components of the server 104 is depicted. The server 104 includes a processor 200 interconnected with a non-transitory computer-readable storage medium, such as a memory 204, and a communications interface 208.

The processor 200 may include a central processing unit (CPU), a microcontroller, a microprocessor, a processing core, a field-programmable gate array (FPGA) or similar. The processor 200 may include multiple cooperating processors. The processor 200 may cooperate with the memory 204 to realize the functionality discussed herein.

The memory 204 may include a combination of volatile (e.g. Random Access Memory or RAM) and non-volatile memory (e.g. read only memory or ROM, Electrically Erasable Programmable Read Only Memory or EEPROM, flash memory). All or some of the memory 204 may be integrated with the processor 200. The memory 204 stores applications, each including a plurality of computer-readable instructions executable by the processor 200. The execution of the instructions by the processor 200 configures the server 104 to perform the actions discussed herein. In particular, the applications stored in the memory 204 include a data management application 212 to aggregate client data from disparate third-party platforms and manage access to the client data by data owners and data collecting entities.

The memory 204 also stores an account database 216 storing accounts for the data owners and the data collecting entities. In particular, the account database 216 may manage data owner accounts, including account data, such as data owner identifiers, login information and passwords, third-party platform connections, and the like. The account database 216 may additionally manage data collecting entity accounts, including account data such as data collecting entity identifiers, login information and passwords, predefined and/or customized graphical representations or reporting structures, and the like.

The memory 204 also includes a raw data repository 220 storing raw client data from the third-party platforms 112. In particular, the raw client data includes the client data as formatted and structured by the third-party platform 112 from which the raw client data is obtained. In some examples, the raw client data received from the third-party platform 112 is stored in association with the data owner account for which the raw client data is retrieved from the third-party platform 112.

The memory 204 also includes a structured data repository 224 storing structured client data. In particular, the structured client data satisfies a common data model and an associated predefined, structured format. The structured format of the common data model may allow for consistent client data, including cross-platform and cross-functional data. The structured client data may further be stored in association with the data owner account for the structured client data. Additionally, in some examples, the structured client data may be associated with data types (e.g., classifying a functional basis for each field of the structured client data, or identifying the third-party platform from which the client data was received) to assist with the aggregation of the structured client data, as will be described further herein.

The memory 204 also includes a permissions database 228 storing permission data defining access permissions between the data owner accounts and the data collecting entity accounts. In particular, the permission data may include associations between the data owner accounts and the data collecting entity accounts. An association between a data owner account and a data collecting entity account represents an authorization for the data collecting entity account to access the client data for the data owner account. Further, each association between a data owner account and a data collecting entity account may additionally specify a data type identifier, representing an authorization for the data collecting entity account to access the client data having a data type corresponding to the data type identifier. Each data owner account may be associated with one or more data collecting entity account, and each data collecting entity account may be associated with one or more data owner accounts.

For example, a given data owner account may be associated with a given accounting firm account. Thus, the accounting firm account may access the client data for the data owner account. Additionally, the data owner account may be associated with a sales firm account. Accordingly, the data owner may wish to provide the accounting firm access to accounting data only, and not customer relationship management data. Thus, the association between the data owner account and the accounting firm account may specify a data type, such as a third-party service identifier (i.e., QuickBooks and NetSuite), or a class of fields (i.e., accounting data encompassing the accounting data from both QuickBooks and NetSuite, while excluding any customer relationship management fields and capabilities of QuickBooks and NetSuite).

In some examples, an account may serve as a data owner account in one association, and a data collecting entity account in another association, and hence the associations may specify the permission granting party (i.e., the party for whom the association is outbound—granting authorization to another account to access the owned client data) and the permission recipient (i.e., the party for whom the association is inbound—receiving an authorization to access the client data owned by another account). Further, as will be appreciated, in some examples, the associations and permission data may be stored in the accounts database in association with the relevant data owner accounts and data collecting entity accounts rather than in an independent database.

The server 104 also includes the communications interface 208 interconnected with the processor 200. The communications interface 208 may be configured for wireless or wired communications and may include suitable hardware (e.g., transmitters, receivers, network interface controllers, and the like) to allow the server 104 to communicate with other computing devices, such as the computing devices 108, the third-party platforms 112, and the computing devices 116. The specific components of the communications interface 208 are selected based on the type of communication links 120 that the server 104 communicates over.

In some examples, the server 104 may further include one or more input and/or output devices (not shown), such as a monitor, display, keyboard, mouse, speakers, or the like to allow an operator to interface with the server 104.

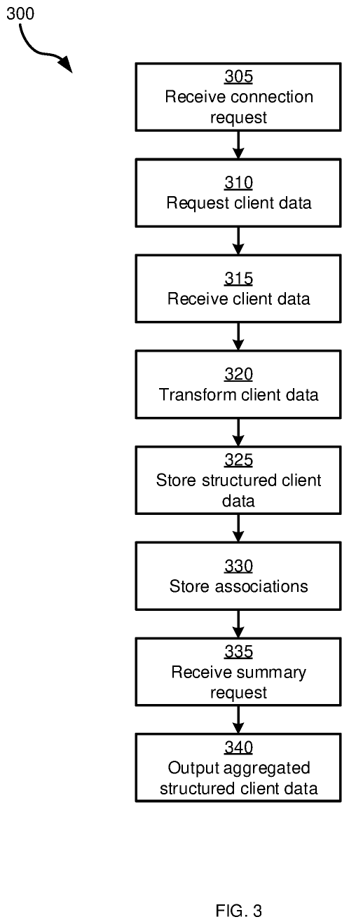

Referring now to FIG. 3, a flowchart of an example method 300 of aggregating client data is depicted. The method 300 will be described in conjunction with its performance in the system 100, and in particular, by the server 104, via execution of the application 212 by the processor 200. In other examples, the method 300 may be performed by other suitable devices and/or systems.

The method 300 is initiated at block 305. At block 305, the server 104 receives a connection request from one of the computing devices 108. The connection request represents a request from a data owner account to connect to a third-party platform 112 to obtain the client data for the requesting data owner account stored at the third-party platform 112. That is, the data owner may have a third-party platform account at the third-party platform 112. Thus, the connection request may specify the data owner account from which the connection request is initiated, as well as an identifier of the third-party platform 112 to connect to.

For example, a data owner may utilize a computing device 108 to access a web page served by the server 104 allowing the data owner to log in to the data owner account. The web page may additionally provide an interface for the data owner to initiate a connection request in association with the data owner account. For example, the web page may display or allow a look-up of available third-party platforms 112 for which the server 104 supports a connection. In response to a selection at the web page, the computing device 108 may initiate the connection request to the server 104.

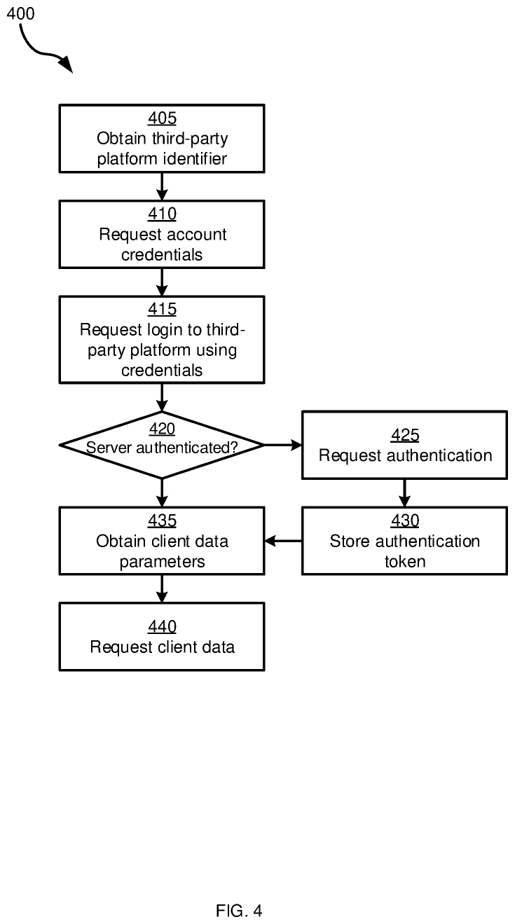

At block 310, in response to the connection request, the server 104 requests client data for the data owner account from the third-party platform 112 identified at block 305. For example, referring to FIG. 4, an example method 400 of requesting client data from a third-party platform 112 is depicted.

At block 405, the server 104 obtains an identifier of the third-party platform 112, for example, by extracting the identifier from the connection request. The server 104 may then determine additional data required to connect to the third-party platform 112 to access the client data. For example, the third-party platform 112 may be account based, and hence may require account credentials to provide access to the client data associated with the data owner account.

Thus, at block 410, the server 104 requests account credentials for the data owner's third-party platform account at the third-party platform 112 identified at block 405 from the computing device 108, and in particular, from the data owner operating the computing device 108. For example, in response to the selection of a third-party platform at the web interface, the server 104 may provide a data entry area at the web interface for the data owner to enter account credentials for the third-party platform 112.

At block 415, the server 104 utilizes the account credentials received at block 410 to request a login at the third-party platform 112. If, at block 415, the account credentials are found to be invalid, the method 400 may return to block 410 to request new account credentials. If the login is successful, the method 400 proceeds to block 420.

In some examples, the third-party platform 112 may additionally require that the server 104 be authenticated to verify that the server 104 is a valid source of a login and data acquisition request. Accordingly, if, at block 420, the server 104 is authenticated with the third-party platform 112, the method 400 proceeds to block 435. For example, the server 104 may submit an authentication token as additional data to the third-party platform 112 when requesting login at block 415.

If, at block 420, the server 104 is not authenticated with the third-party platform 112, the method 400 proceeds to block 425. For example, authentication tokens may change periodically, and hence a previously stored authentication token may be invalid. Accordingly, at block 425, the server 104 requests authentication with the third-party platform 112. The third-party platform 112 may then perform a verification to validate the authentication request; the server 104 may respond and provide verification information accordingly.

At block 430, the server 104 stores an authentication token to allow for a more straightforward authentication process in subsequent iterations of the method 400. That is, in response to a successful authentication of the server 104 by the third-party platform 112, the third-party platform 112 may issue an authentication token to the server 104 indicating some level of authentication with the third-party platform 112. Having successfully authenticated with the third-party platform 112, the server 104 then proceeds to block 435.

At block 435, the server 104 obtains client data parameters. In particular, the client data parameters define the scope of the client data to obtain from the third-party platform 112. For example, the client data parameters may specify a sub-account information. That is, the data owner account at the third-party platform 112 may have sub-accounts (e.g., particular portfolios, projects, bank accounts, or the like). Accordingly, the server 104 may, in such examples, receive the sub-account information from the third-party platform 112 and relay the sub-account information to the computing device 108 (e.g., for display at the web interface). The data owner may then specify the sub-account from which client data is to be retrieved. In some examples, the data owner may specify multiple sub-accounts. This sub-account information is returned to the server 104 by the computing device 108 as the client data parameters. In other examples, the client data parameters may specify additional information, such as a particular date range or the like. Such client data parameters may additionally be received from the computing device 108 in response to input from the data owner.

At block 440, the server 104 requests the client data from the third-party platform 112 in accordance with the client data parameters determined at block 435. The server 104 then returns to block 315 of the method 300.

Accordingly, returning to FIG. 3, at block 315, the server 104 receives the client data from the third-party platform 112. In particular, the client data as received from the third-party platform 112 may also be referred to herein as the raw client data. That is, the raw client data is the client data as formatted and structured by the third-party platform. The raw client data obtained at block 315 is stored in the raw data repository 220. In some examples, the raw client data obtained at block 315 is stored in the raw data repository 220 in association with the data owner account.

At block 320, the server 104 maps the raw client data according to a common data model to generate structured client data. That is, the server 104 has a common data model defining a structured format for storing client data. Accordingly, the server 104 applies a transformation to the raw client data to reformat the raw client data to the structured format of the common data model. In some examples, the common data model may include structure for cross-functional client data. For example, the common data model may map both financial and/or accounting data, as well as customer relationship management data.

The mapping of the raw client data to the structured format of the common data model may be defined based on a pre-defined mapping, defined, for example in a configuration table stored at the server 104, and in particular, in the memory 204. The configuration table may define particular mappings from the source schema and fields (i.e., the schema and fields used by the third-party platforms 112) to the destination schema and fields (i.e., the structured format of the common data model of the server 104). The server may transform the raw client data, for example using an iterative process on each field in the raw client data which involves data structure manipulation.

Advantageously, the cross-functionality of the common data model may allow for a more robust data population. For example, some third-party platforms 112 may store information about the data owner (e.g., name, address, contact information, etc.), while others may not. Alternately, records at the different third-party platforms 112 may be incomplete. Accordingly, when raw client data is mapped to the structured data format, some cross-functional, generically applicable fields, such as data owner information, may be extrapolated and stored in association with the structured client data.

At block 325, the server 104 stores the structured client data in the structured data repository 224.

At block 330, the server 104 may receive, from the computing device 108, a data collecting entity connection request. The connection request represents a request from a data owner account to authorize a data collecting entity to access the client data for the data owner account. Thus, the connection request may specify the data owner account from which the connection request is initiated, as well as an identifier of the data collecting entity. Further, the connection request may additionally specify a data type for the client data that the data collecting entity account is to have access to. The data type may be, for example, an identifier of a third-party service, or a class of fields.

For example, the data owner operating the computing device 108 may continue to interact with the web page served by the server 104. The web page may provide an interface for the data owner to initiate a connection request to a data collecting entity. For example, the web page may display or allow a look-up of available data collecting entities having a data collecting entity account at the server 104. The web page may additionally allow selection or input of the data type to authorize to the data collecting entity account. For example, the web page may allow selection of third-party platforms 112 connected to the data owner account (e.g., QuickBooks account, FreshBooks account, etc.) or selection of classes of fields (e.g., accounting data).

Upon receipt of the connection request, the server 104 stores the permission data in the permissions database 228. In particular, the server 104 stores the association between the data owner account and a data collecting entity account.

At block 335, the server 104 receives a summary request for a data collecting entity account. The summary request represents a request to aggregate the client data accessible by the data collecting entity and output the aggregated client data to the data collecting entity account.

For example, a data collecting entity may utilize a computing device 116 to access a web page served by the server 104 allowing the data collecting entity to log in to the data collecting entity account. The web page may additionally provide an interface for the data collecting entity to initiate a summary request. In other examples, the web page request itself (i.e., the landing page after login to the data collecting entity account) may act as the summary request for the server 104.

In another example, the data collecting entity may utilize the computing device 116 to send the summary request to an application programming interface (API) provided by the server 104. In particular, the data collecting entity may desire a structured data object to allow them to acquire the data in a machine-readable format to import the data into their own systems (e.g., operated by the computing device 116) for further analysis. The API provided by the server 104 may allow data collecting entities to specify particular fields (e.g., by the classification of the field, or by selecting individual fields) and data object format (e.g., JSON file, CSV, etc.) in the summary request.

At block 340, the server 104 aggregates the client data for data owner accounts associated with the data collecting entity account. In particular, to simplify the aggregation of the client data and to allow analysis and interpretation of the aggregated client data, the aggregated client data is an aggregation of the structured client data. The server 104 then outputs the aggregated structured client data.

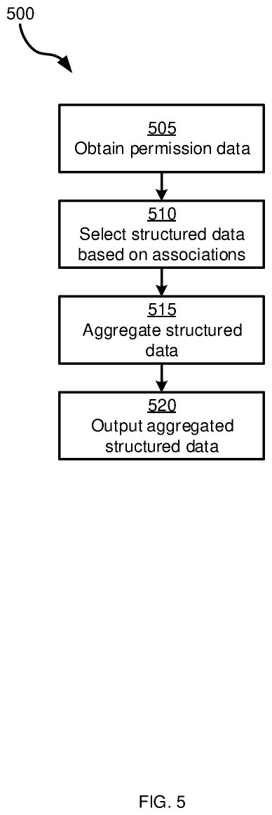

For example, referring to FIG. 5, an example method 500 of aggregating client data is depicted.

At block 505, the server 104 obtains permission data from the permissions database 228. In particular, the server 104 retrieves the associations for the data collecting entity account requesting the summary. The server 104 uses the associations to identify the data owner accounts which have granted the data collecting entity account access to their respective client data. The server 104 may also use the associations to identify, for each data owner account, the data type of the client data to be accessed by the data collecting entity account.

At block 510, the server 104 selects a subset of the structured client data based on the permission data (i.e., the associations) obtained at block 505. In particular, the server 104 selects lines of the structured client data associated with one of the data owner accounts identified at block 505 as being associated with (i.e., granting access permissions to) the data collecting entity account requesting the summary. The server 104 may further filter the selected lines based on the data type of the structured client data contained in each line. That is, lines of structured client data having a data type not specified in the association between the data owner account and the data collecting entity account may be filtered out.

In some examples, at block 510, prior to selecting the structured client data to aggregate, the server 104 may perform a synchronization of the client data for the data owner accounts identified at block 505, to ensure that the structured client data aggregated at block 510 is up to date.

At block 515, the server 104 aggregates the structured client data selected at block 510. For example, the server 104 may generate one or more graphical representations of the aggregated structured client data. In particular, the server 104 may retrieve, from the account database 216, predefined and/or customized graphical representation parameters or reporting structures and may generate the graphical representations or reports in accordance with the specified parameters. The graphical representations may include, for example, line graphs, charts, pie graphs, or other graphical representations of the aggregate structured client data. As will be appreciated, each graphical representation may represent or display certain aspects or trends of the aggregated structured client data. That is, each graphical representation may highlight, and therefore utilize, a subset of the structured client data selected at block 510, based on the parameters of the graphical representation.

In another example, the server 104 may generate a structured data object, such as an array including the aggregated structured data selected at block 510. A structured data object may be generated, for example, in response to a summary request received via API at the server 104. As noted above, the API may allow the summary request to specify particular fields (e.g., by field classification or by individual field identifiers), and hence at block 515, the server 104 may further filter the aggregated structured client data based on the parameters of the summary request. The API may additionally allow the summary request to specify a data object format. Accordingly, the structured data object is generated in accordance with the parameters specified in the summary request

At block 520, the server 104 outputs the aggregated structured data generated at block 515. In particular, the server 104 returns the aggregated structured client data to the computing device 116 associated with the data collecting entity account which initiated the summary request. For example, when the summary request is initiated by a web page request, the server 104 may return a web page including the graphical representations to be displayed at the computing device 116 operated by the data collecting entity. In other examples, the server 104 may return other requested reports or other means of displaying the aggregated structured client data to the computing device 116 for display at the web interface. In still further examples, when the summary request is initiated by a request from the computing device 116 at the API of the server 104, the server 104 may return a structured data object to the computing device 116. In particular, the structured data object may satisfy the parameters specified in the summary request.

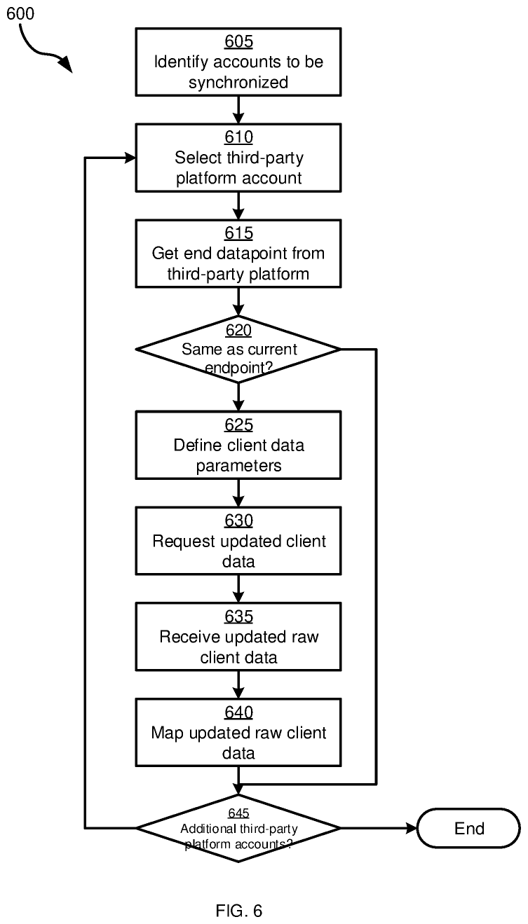

As noted above, in some examples, the server 104 may perform synchronizations to acquire updated client data. Referring now to FIG. 6, an example method 600 of synchronizing client data is depicted.

The method 600 is initiated at block 605, for example, in response to a synchronization trigger. The synchronization trigger may include the passage of a predetermined period of time (i.e., the server 104 may be configured to perform a periodic synchronization), or a synchronization request. The synchronization request may be initiated, for example, by a data owner (e.g., via interaction with the web interface at the computing device 108) or by a summary request for a data collecting entity account. At block 605, the server 104 determines the data owner accounts to be synchronized. For example, when the synchronization is a periodic, scheduled synchronization, the server 104 may identify all the data owner accounts to be synchronized. When the synchronization is triggered by a summary request for a data collecting entity account, the server 104 may identify the data owner accounts associated with the data collecting entity account to be synchronized. Further, for each data owner account, the server 104 may identify a third-party platform account associated with the data owner account to be synchronized. Thus, the time and resources required to complete the synchronization in real-time in response to the summary request may be reduced.

At block 610, the server 104 selects a third-party platform account to be synchronized.

At block 615, the server 104 obtains an end datapoint from the third-party platform account. That is, the end datapoint from the third-party platform account may represent a most recent datapoint recorded at the third-party platform (e.g., a most recent transaction, posting, or the like).

At block 620, the server 104 obtains a current endpoint from the client data stored at the server 104. For ease of comparison, the server 104 may obtain the current endpoint from the raw client data in the raw data repository. The server 104 compares the current endpoint to the end datapoint and determines whether they are the same. If the determination is affirmative, the server 104 determines that no synchronization is required for the third-party platform account. The server 104 may mark the third-party platform account as synchronized and proceeds to block 645.

If the determination is negative at block 620, the server 104 determines that a synchronization is to be performed and proceeds to block 625. At block 625, the server 104 determines the client data parameters based on previously stored client data parameters, as well as the current endpoint of the client data. In particular, the server 104 may specify a parameter that client data recorded after the current endpoint is to be obtained. Thus, the time and resources to complete the synchronization, and the amount of data transferred between the third-party platform 112 and the server 104 may be reduced.

At block 630, the server 104 requests the client data from the third-party platform 112 in accordance with the client data parameters determined at block 625. In particular, the server 104 may request the raw client data recorded after the current endpoint as the updated raw client data.

At block 635, the server 104 receives updated raw client data from the third-party platform 112 and may store the updated raw client data at the raw data repository 220.

At block 640, the server 104 maps the updated raw client data according to the common data model to generate updated structured client data. The updated structured client data is stored in the structured data repository 224. The server 104 may then determine that the third-party platform account has been updated and mark it as synchronized.

At block 645, the server 104 determines if there are any additional third-party platform accounts from the list identified at block 605 that are unsynchronized (i.e., have not yet been marked as synchronized during execution of the method 600). If the determination is affirmative, the method 600 returns to block 610 to select another unsynchronized third-party platform account. If the determination at block 645 is negative, the method 600 ends.

As described above, a server may be configured to obtain client data for various data owner accounts from various disparate third-party platforms. The server transforms the disparate client data according to a common data model and stores the resulting structured client data. The server therefore allows client data to be obtained for multiple data owners, and across multiple varying third-party platforms for each data owner and across data owners. The resulting structured client data allows meaningful sharing and comparability of data between organizations. Additionally, the server supports cross-functional third-party platforms to allow for more robust data population in the structured client data. The structured client data may be aggregated and shared to a data collecting entity, such as a bank, lender, professional services firm, or the like. Accordingly, the server may store associations specifying parameters of what client data each data collecting entity has access to. The structured client data can be analyzed and aggregated for the data collecting entity, allowing the data collecting entity to view trends and insights across multiple data owners using a variety of disparate third-party platforms to store their client data simultaneously.

The scope of the claims should not be limited by the embodiments set forth in the above examples but should be given the broadest interpretation consistent with the description as a whole.

1. A method comprising:
storing, at a server, associations between a plurality of data owner accounts and a data collecting entity account;
for each data owner account:
obtaining, from a respective third-party platform, raw client data associated with the data owner account;
mapping the raw client data according to a common data model to generate structured client data; and
storing the structured client data at a structured data repository; and
in response to a summary request for the data collecting entity account, aggregating the structured client data for the data owner accounts associated with the data collecting entity account and outputting the aggregated structured client data.

2. The method of claim 1, wherein obtaining the raw client data from the third-party platform comprises:
receiving, from the data owner account, a connection request identifying the third-party platform, wherein the data owner account has a third-party platform account with the third-party platform; and
requesting the raw client data associated with the third-party platform account at the third-party platform.

3. The method of claim 2, further comprising, prior to requesting the raw client data from the third-party platform:
obtaining additional data to access the raw client data associated with the third-party platform; and
providing the additional data to the third-party platform to access the raw client data associated with the third-party platform account.

4. The method of claim 3, wherein the additional data comprises one or more of:
account credentials; and network authentication tokens; sub-account information; and
client data parameters.

5. The method of claim 1, further comprising, in response to a synchronization trigger:
for each data owner:
obtaining, from the respective third-party platform, updated raw client data;
mapping the updated raw client data according to the common data model to generate updated structured client data; and
storing the updated structured client data at the structured data repository.

6. The method of claim 5, wherein the synchronization trigger comprises one of:
passage of a predetermined period of time; or a synchronization request.

7. The method of claim 5, wherein obtaining the updated raw client data comprises:
determining a current endpoint of the raw client data; and
requesting, from the third-party platform the raw client data recorded after the current endpoint as the updated raw client data.

8. The method of claim 1, further comprising, in response to the summary request:
generating one or more graphical representations of the aggregated structured client data; and
returning the graphical representations to a computing device associated with the data collecting entity account for display at a web interface.

9. The method of claim 1, further comprising, in response to the summary request:
generating a structured data object according to parameters specified in the summary request; and
returning the structured data object to a computing device associated with the data collecting entity account.

10. The method of claim 1, further comprising:
storing, for each association between a data owner account and the data collecting entity account, a data type identifier; and
wherein aggregating the structured client data comprises:
retrieving the associations between the data owner accounts and the data collecting entity account;
selecting a subset of the structured client data based on the associations; and
aggregating the selected subset to generate the aggregated structured client data.

11. A server comprising:
a memory configured to store associations between a plurality of data owner accounts and a data collecting entity account;
a processor interconnected with the memory, the processor configured to:
for each data owner account:
obtain, from a respective third-party platform, raw client data associated with the data owner account;
map the raw client data according to a common data model to generate structured client data; and
store the structured client data at a structured data repository; and
in response to a summary request for the data collecting entity account, aggregate the structured client data for the data owner accounts associated with the data collecting entity account and outputting the aggregated structured client data.

12. The server of claim 11, wherein, to obtain the raw client data from the third-party platform, the processor is configured to:
receive, from the data owner account, a connection request identifying the third-party platform, wherein the data owner account has a third-party platform account with the third-party platform; and
request the raw client data associated with the third-party platform account at the third-party platform.

13. The server of claim 12, wherein, prior to requesting the raw client data from the third-party platform, the processor is further configured to:
obtain additional data to access the raw client data associated with the third-party platform; and
provide the additional data to the third-party platform to access the raw client data associated with the third-party platform account.

14. The server of claim 13, wherein the additional data comprises one or more of:
account credentials; and network authentication tokens; sub-account information; and
client data parameters.

15. The server of claim 11, wherein, in response to a synchronization trigger, the processor is configured to:
for each data owner:
obtain, from the respective third-party platform, updated raw client data;
map the updated raw client data according to the common data model to generate updated structured client data; and
store the updated structured client data at the structured data repository.

16. The server of claim 15, wherein the synchronization trigger comprises one of:
passage of a predetermined period of time; or a synchronization request.

17. The server of claim 15, wherein to obtain the updated raw client data, the processor is configured to:
determine a current endpoint of the raw client data; and
request, from the third-party platform the raw client data recorded after the current endpoint as the updated raw client data.

18. The server of claim 11, wherein, in response to the summary request, the processor is further configured to:
generate one or more graphical representations of the aggregated structured client data; and
return the graphical representations to a computing device associated with the data collecting entity account for display at a web interface.

19. The server of claim 11, wherein, in response to the summary request, the processor is further configured to:
generate a structured data object according to parameters specified in the summary request; and
return the structured data object to a computing device associated with the data collecting entity account.

20. The server of claim 11, wherein the processor is further configured to:
store, for each association between a data owner account and the data collecting entity account, a data type identifier; and
wherein to aggregate the structured client data, the processor is configured to:
retrieve the associations between the data owner accounts and the data collecting entity account;
select a subset of the structured client data based on the associations; and
aggregate the selected subset to generate the aggregated structured client data.
